(19) United States
(12) Patent Application Publication
(10) Pub. No.: US 2021/0307986 A1
(43) Pub. Date: Oct. 7, 2021

(54) HYGIENIC CONTAINMENT CHAMBER

(71) Applicant: Katarzyna Suberska Weitz, Holland, PA (US)

(72) Inventor: Katarzyna Suberska Weitz, Holland, PA (US)

(21) Appl. No.: 17/220,899

(22) Filed: Apr. 1, 2021

Related U.S. Application Data
(60) Provisional application No. 63/005,523, filed on Apr. 6, 2020.

(51) Int. Cl. A61G 10/00

(52) U.S. Cl. CPC A61G 10/005

(57) ABSTRACT

The present invention generally relates to a hygienic chamber, and more particularly to a hygienic containment chamber for procedures such as medical, dental, and aesthetic procedures. In some scenarios, the containment chamber may be configured to provide a substantially enclosed workspace to protect medical professionals, healthcare providers, or aestheticians and their patients or clients, for example, by reducing their exposure and cross contamination to one another during various operations or procedures.

### CROSS-REFERENCE TO RELATED APPLICATIONS

This application claims the benefit of U.S. Provisional Application No. 63/005,523, filed Apr. 6, 2020 and entitled HYGIENIC CONTAINMENT CHAMBER, the entire disclosure of which is hereby incorporated by reference in its entirety.

### FIELD OF THE INVENTION

The present invention generally relates to a hygienic chamber, and more particularly to a hygienic containment chamber for procedures such as medical, dental, and aesthetic procedures.

### BACKGROUND

Generally, healthcare practitioners are required to exercise “universal precautions” to provide a safe operatory field by cleaning the operatory field with appropriate agents and covering select areas with disposable materials to uphold the hygiene of certain equipment. In some scenarios, the operatory field may be at risk of contamination due to known or unknown particles that may be introduced during a given operation. This risk may include infecting the health practitioners, for example, dentists, their assistants and technicians, as well as their patients. Presently, there is no known barrier enclosure which is configured to protect both the operators, for example, the healthcare practitioners, or the patient from contaminants, for example, splash produced during a given procedure.

Therefore, there is a need for a sterile environment for health professionals and their assistants, for example, dentists and dental assistants, to reduce exposure and cross contamination during various procedures in which the health professionals are required to work with or on patients. The present disclosure relates to an enclosed, environmentally sanitized work space in which a health professional, for example, a dentist or dental assistant, can physically perform a procedure without the risk of contaminating the open area around the operation, for example, the dental operatory.

The containment chamber of the present disclosure may be configured to provide a substantially enclosed workspace to protect doctors and patients, for example, by reducing their exposure and cross contamination to one another during various operations or procedures. These and other features and advantages of the present invention will be explained and will become obvious to one skilled in the art through the summary of the invention that follows.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1 is a perspective view of an exemplary containment chamber with a chamber component disconnected from a support component in accordance with an embodiment of the present invention.

FIG. 2 is an expanded perspective view of an exemplary containment chamber with a chamber component connected to a support component in accordance with an embodiment of the present invention.

FIG. 3 is a top perspective view of an exemplary chamber component of a containment chamber in accordance with an embodiment of the present invention.

FIG. 4 is a bottom perspective view of an exemplary chamber component of a containment chamber in accordance with an embodiment of the present invention.

FIG. 5 is an exploded view of an exemplary chamber component of a containment chamber in accordance with an embodiment of the present invention.

FIG. 6 is a perspective view of an exemplary support component of a containment chamber in accordance with an embodiment of the present invention.

FIG. 7 shows a top view of an exemplary support component of a containment chamber in accordance with an embodiment of the present invention.

FIG. 8 is a first side view of an exemplary support component of a containment chamber in accordance with an embodiment of the present invention.

FIG. 9 is a second side view of an exemplary support component of a containment chamber in accordance with an embodiment of the present invention.

FIG. 10 is a perspective view of an exemplary containment chamber connected to a medical chair in accordance with an embodiment of the present invention.

### OBJECTS AND BRIEF SUMMARY OF THE INVENTION

It is an objective of the invention disclosed herein to provide a sterile and contained, enclosed workspace configured to be placed over a designated portion of a patient's body, for example, a patient's upper torso and facial area, on a medical exam chair, for example, a dentist's dental chair. The containment chamber of the present disclosure may be used by a healthcare professional, for example, a dentist, dental assistant or technician, doctor or cosmetologist to perform a selected procedure or examination, for example, during dental, medical, cosmetologic examinations and procedures in a contained space which may be configured to maintain a patient's comfort and safety. In some embodiments of the present invention, the materials used may allow oxygen to enter the enclosed space, providing the patient with a ventilated environment and permitting a healthcare professional, for example, a dentist or dental assistant, to perform select procedures.

It is another object of the invention disclosed herein to minimize the risk of contamination of the entire operatory field from foreign known and unknown contagious particles spread by the droplets created by medical instrumentation, for example, dental instrumentation, which places medical professionals, for example, dental workers, at risk.

It is another object of the present invention to minimize the risk to any patient that may or may not be exposed to anyone or any aerosolized particles unknown to the patient.

It is another object of the present invention to substantially enhance the visibility of an enclosed working environment for an aesthetician or medical professional, for example, a dentist or dental assistant which may require a specific amount of space, including room for equipment, for example, a dental tray, handpieces, evacuation lines, air inlets and/or any other equipment that may be used by dentists, medical doctors, or aestheticians utilizing the device, while maintaining visibility of the client or patient, for example, the client or patient's head.

Embodiments of the present invention achieve the above objects by, in some instances, providing a transparent enclosure forming a protected workspace with ports or holes designated for hands or hardware. In accordance with embodiments of the present invention, the containment chamber may be large enough to permit the unobstructed use of hands and ordinary dental hand-instruments for adjusting and manipulating a patient's teeth in the mouth. The openings, for example, the hand-openings, may be formed in a variety of sizes to accommodate different positions for procedures. For example, the hand-openings may be large enough to enable the unobstructed insertion of an operator's hands and tools, yet small enough to prevent foreign or contagious particles from leaving the enclosed space.

### DETAILED DESCRIPTION OF ILLUSTRATIVE EMBODIMENTS

In the Summary above and in this Detailed Description, and the claims below, and in the accompanying drawings, reference is made to particular features of various embodiments of the invention. It is to be understood that the disclosure of embodiments of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

According to embodiments of the present invention, a medical containment chamber may be configured to provide a sterile and contained, enclosed workspace configured to be placed over a designated portion of a patient's body, for example, a patient's upper torso and facial area, on a medical exam chair, for example, a dentist's dental chair. The containment chamber of the present disclosure may be used by a healthcare professional, for example, a dentist, dental assistant or technician, to perform a selected procedure in a contained space which may be configured to maintain a patient's comfort and safety. In some embodiments of the present invention, the materials used may allow oxygen to enter the enclosed space, providing the patient with a ventilated environment and permitting an aesthetician, dental or healthcare professional, for example, a dentist or dental assistant, to perform select procedures.

Embodiments of the present invention are directed towards a containment chamber comprising a chamber component adapted to encase a patient and form a protected workspace with openings and/or ports designated for the insertion of hands and/or hardware. In some embodiments, the containment chamber may permit the unobstructed use of hands and ordinary dental hand-instruments, for example, to permit the adjusting and manipulating a patient's teeth and/or mouth within the confines of the containment chamber. The hand-openings may be formed in a variety of sizes to accommodate different positions for the same or different procedures. For example, the hand-openings may be large enough to enable the unobstructed insertion of an operator's hands and/or arms and tools into the chamber, yet small or enclosed enough to prevent foreign or contagious particles from leaving the substantially enclosed containment chamber. In some embodiments, the openings and/or ports may be lined with a material adapted to create a seal around the holes or ports, for example, a rubber material.

The containment chamber of the present disclosure is contemplated for use in an assortment of settings and for one to a plurality of uses including, for example, during dental, medical, or cosmetologic examinations and procedures. The device may be customized for a particular use or may be universal, for example, to permit its use in a plurality of scenarios. Additionally, the device may be configured to be mobile (e.g. portable), for example, the device may be configured to be freestanding so that it may be installed onto a chair or bed (e.g. a medical chair or examination table) and may have wheels, for example, caster wheels, enabling the device to be easily moved or otherwise re-located. In some examples, a freestanding containment chamber may be used in a variety of settings including, for example, hostile or temporary style environments.

In accordance with embodiments of the present invention, a hygienic containment chamber may comprise a chamber component. In some embodiments, the chamber component may be configured as a flexible barrier or enclosure between a patient body part and a medical professional, for example, a doctor or doctor's assistant. In some examples, the chamber component may be configured to drape above or over a given patient body part. In some embodiments, the chamber component may be configured to operably connect to a support component. For example, in some embodiments, c-shaped clips may be utilized to selectively fasten the chamber component to a support component. In some examples, the clips may be c-shaped cylinders formed with or otherwise connected to an edge portion of the containment chamber barrier and may be adapted to connect to the frame of the support component. In some embodiments, the clips may be any other similarly suitable releasable fastener such as hook and loop fasteners, magnets, snap buttons, zippers, and other similar releasable fasteners. In some embodiments, the support component may comprise a frame configured to provide structure to at least a portion of the chamber component.

In accordance with embodiments of the present invention, the sub-components of the chamber component and/or the support component may be disposable and/or non-disposable. In a preferred embodiment, the barrier of the chamber component is disposable.

In accordance with embodiments of the present invention, the support component may include a frame having one or more supporting posts configured to support the barrier of the chamber component. In some examples, the frame may comprise a top frame section and a bottom frame section. In some embodiments, the top frame section may be configured to receive and support at least a portion of the chamber component. For example, the top section of the frame may comprise a support mount having one or more support rods adapted to support a portion of the chamber component, for example, a viewing window of the chamber component. In any embodiment, the support mount may be configured to provide structure to the chamber component. Moreover, the height of the support component (e.g. the distance from the ground to the top of the support component) may be fixed or adjustable. For example, the posts of the support component may comprise one or more telescoping components configured to permit a user to adjust the height of the support component. In some embodiments, the sub-components of the support component may be formed of any suitable support material including, for example, rigid plastic, carbon fiber, or metal.

In accordance with embodiments of the present invention, the support mount configured to support at least a portion of the chamber component may be a unitary member or may be formed of numerous components. For example, the support mount may be a unitary member formed in a predetermined shape, or the support mount may comprise two or more components configured to collectively form a predetermined shape. For example, the support mount may be formed by one or more support rods connected by one or more connector members, for example, elbow shaped connector members, to form a rectangular support mount. In some embodiments, the connector members may be elbow shaped pipes configured to receive and fasten the support rods. In any embodiment, the connector members may be or comprise adhesives, screws, pins and/or other similar connecters which may be suitable for connecting the support rods to one another in any desirable shape or orientation. The support mount may be formed in any shape or orientation, including, for example, square, rectangular, triangular, circular, hexagonal, diamond, rhomboid, or any other shapes and orientations.

In some embodiments of the present invention, the support component may be configured to permanently or removably attach to a medical exam chair, for example, a dental exam chair. For example, a permanently attached support component may be configured to a back portion of a medical chair, and may swivel or swing to selectively cover a person (e.g. a patient) sitting in the chair. In some embodiments, the support component may be attached to a mobile frame which may be configured to slide or roll under the medical exam chair. In some embodiments, the support component may be manufactured as part of the medical exam chair. In some examples, a support component configured to releasably or removably attach to a medical exam chair may include removable bands, for example, elastic bands, configured to releasably secure the support component to a selected medical exam chair.

In accordance with embodiments of the present invention, the support component may include a top cover. In some embodiments, the top cover may be removable to assist in securing a portion of the chamber component, for example, the barrier of the chamber component, to the support component. For example, the top cover of the support component may selectively attach to a top portion of the support component and may assist in releasably securing the viewing window of the chamber component to the support component. The top cover may attach to the support component in any suitable way, including by means of clips, buttons (e.g. snap buttons), hook and loop fasteners, and other similarly suitable releasable fasteners.

In accordance with embodiments of the present invention, the dimensions of the support component and/or any of its sub-components may vary depending on the size of an intended user (e.g. patient). In some embodiments, the dimensions of the support component may be adjustable or fixed. In some embodiments, the support component may be secured to a surface (i.e. fixed or immobile), for example, a chair, or may be mobile (e.g. portable).

In accordance with embodiments of the present invention, the chamber component may comprise a barrier. In some embodiments, the barrier may comprise at least one sheet of flexible material and may include a plastic material connected (e.g. fused) to breathable material at the bottom portion of the barrier. In some embodiments, the breathable material is not water permeable. In some embodiments, the plastic material may be formed of polyethylene. In some embodiments, the plastic material may be thin and/or substantially flexible. In some embodiments, the plastic material may be substantially rigid, for example, formed of Plexiglas. In some scenarios, the plastic material may be transparent. The transparency of the plastic material may provide visibility into the chamber component and may reduce the feeling of confinement for the person placed within the chamber component.

In some embodiments, a top portion of the containment chamber may include an opening configured to receive a viewing window or screen which may provide visibility into the interior of the chamber. In some examples, the window may provide a convenient means for a user of the containment chamber, for example, a medical professional, to view the interior of the containment chamber during any given procedure. In some examples, the window may provide substantial visibility (e.g. full visibility) of the body part placed in the containment chamber, for example, a patient's face or upper torso, for the purposes of accuracy and, in some scenarios, adjustments, if necessary. In some embodiments, the window may permit the use (e.g. does not obstruct the use of) a medical professional's, for example, a dentist's, over-head lamp without disturbing the dentist's performance of a given examination or procedure.

In accordance with embodiments of the present invention, the screen or window of the chamber component may be formed of any suitable substantially transparent material, for example, flexible plastic, rigid plastic, Plexiglas, tempered glass, or magnifying glass. The window may be formed as part of the barrier of the chamber component, or may be a separate unit configured to attach to the barrier. In some embodiments, the viewing window may be formed on a top sidewall of the barrier. In some embodiments, the barrier may be formed with an opening adapted to receive the viewing window. In some embodiments, one or more fastening members may be utilized to fasten the viewing window to the barrier opening. For example, the fasteners may be clips or any other suitable fasteners which may be adapted to permanently or releasably fasten the viewing window to the opening in the barrier. In some embodiments, the viewing window may include one or more inlets for one or more instruments, for example, an inlet for a microscope or camera entrance. In some embodiments, the viewing window may be a “tight fitted” plastic insert permitting the view of a person (e.g. a patient) inside the containment chamber. In some embodiments, the viewing window may house a camera or mirrors to enlarge the working field. In some embodiments, lights, for example, UV or LED lights, may be added along the viewing window to illuminate the chamber and assist in providing microbial control.

In accordance with embodiments of the present invention, the containment chamber may include a filter, for example, a High Efficiency Particulate Air (HEPA) filter. In some embodiments, the filter may be configured to filter the air in the containment chamber.

In accordance with embodiments of the present invention, the chamber component may include an examination aperture configured to receive a patient body part for inspection, examination, operation or procedure. For example, the examination aperture may be an opening in the barrier configured to receive a patient's head or face such that the person's head or face is the only part of the person which is exposed to the containment chamber environment. In some embodiments, the examination aperture may include a lining or membrane, for example, a rubber lining or membrane, configured to tightly receive a patient body part, and prevent the escape of any particles from within the containment chamber throughout a given procedure. In any embodiment, the chamber component may be configured to permit a person's (e.g. a patient's) head, hand, foot, or any other body part to be isolated within the containment chamber.

In accordance with embodiments of the present invention, the chamber component may include one or more openings configured to receive the hands and/or arms of a user, for example, a physician, physician's assistant, technician or other medical personnel. Specifically, one or more side walls of the barrier may include one or more hand-openings. In any embodiment, the hand-openings may provide a user with physical access into the interior of the barrier. In an exemplary embodiment, the sidewalls of the barrier may include four hand-openings. In some embodiments, the hand-openings may be provided in pairs. The hand-openings may be formed in any shape suitable to permit a user's hand and/or arm to be inserted into the chamber component, for example, circle, square or oval shaped openings. In some embodiments, the hand-openings may be configured as holes or slits, in each case, configured to allow a user to pass their hand through the barrier of the chamber component, for example, through the thin, flexible material of the barrier and into the chamber component. In some embodiments, the slits may be formed in any given design, including “+”, “−”, “X”, “Y”, “T”, “H” or any other similarly suitable slit design. In some embodiments, the hand-openings may be perforated slits adapted to open up or widen upon application of external pressure.

In an exemplary usage scenario, a dentist may insert his or her hands into a first pair of hand-openings and a dental assistant may insert his or her hands into a second pair of hand-openings during a given operation. In some embodiments, the hand-openings may extend toward sleeves and/or gloves adapted for utilization within the containment chamber. For example, an edge portion of the hand-openings may be sewn, fused, glued or otherwise attached to sleeves and/or gloves. In some embodiments, the hand-openings may include releasable fasteners configured to releasably fasten the sleeves and/or gloves to the hand-openings. The releasable fasteners may be, for example, hook and loop fasteners, buttons, magnets, or any other suitable releasable fasteners for releasably fastening the hand-openings to the sleeves and/or gloves. In some embodiments, the hand-openings may include a membrane, for example, a rubber membrane configured to prevent matter external to the containment chamber (aside from an operator's hands) from entering into the containment chamber as well as assist in preventing particles within the containment chamber from escaping. In some embodiments, the membrane may be configured to permit the insertion of hands of an operator who is geared, for example, an operator wearing personal protective equipment (PPE) and gloves.

In accordance with embodiments of the present invention, the chamber component may include one or more ports configured to receive tools. In an exemplary embodiment, the sides of the chamber component may include six ports, for example, three ports on a first side and three ports on the second side of the chamber component. The ports may be configured to receive, for example, evacuation lines, hand pieces, air syringes and/or water syringes. In some examples, a port may be configured to receive an air flow device, for example, a continuous positive airway pressure (CPAP) device.

In accordance with embodiments of the present invention, the barrier of the chamber component may include skirted sides with a breathable fabric (e.g. a high breathable fabric) that may permit the one-way flow of oxygen and prevent the exit of any potentially hazardous particles (e.g., bacteria or viruses) from within the containment chamber.

In accordance with embodiments of the present invention, the chamber component may be substantially bag-like, having a front portion with at least one opening extending towards rear portion having a sealed end. In any embodiment, the sealed end may be configured to maintain the contents of the bag within the chamber component, and may formed by the adhesion of one or more barrier sidewalls to one another, or by a knot formed at a tail end of the chamber component. When a given procedure or examination is completed, the chamber component, including any potentially infected areas or surfaces, may be collapsed, closed, and disposed safely into a proper waste disposal unit.

In accordance with embodiments of the present invention, the barrier may include a safety flap. In some embodiments, the safety flap may be adapted to selectively open and/or close and may enable the removal of instruments (e.g. contaminated instruments), for example, after a given procedure or examination is completed.

In accordance with embodiments of the present invention, the chamber component may include a tray removal opening. The tray removal opening may be configured to permit instrument removal, for example, near a patient's hand position. In an exemplary usage scenario, at the conclusion of a given procedure, the instruments used during the procedure may be bagged inside the containment chamber and passed through the tray removal opening, for proper disposal. In some examples, the instruments may then be draped and removed from the operatory field for sterilization.

In accordance with embodiments of the present invention, the chamber component and the support component may include or may be comprised of autoclavable materials or components. In some examples, the one or more components of the support component or the chamber component may be formed of substantially sterilizable materials.

The containment chamber may vary in size depending on the intended application of the device, the body part intended to be enclosed by the chamber, or the size of the patient. For example, in some scenarios, the containment chamber may be smaller or larger, depending on the intended use of the device, for example, a smaller containment chamber may be used during an aesthetic procedure on a person's hand or foot, while a larger containment chamber may be used during a medical procedure on a patient torso. In some scenarios, the containment chamber may be smaller or larger depending on the size of the intended person or patient meant to be contained within the containment chamber, for example, based on the size of an adult patient or a pediatric patient. For example, for an average adult, the containment chamber may be approximately 30 in×30 in×22 in in size, making it a workable containment space and providing enough room for two sets of hands (e.g. the hands of a dentist and dental assistant) required for performing a procedure or examination, for example, a dental procedure, which in turn may offer a major reduction in risk to the environment outside the containment area. In some embodiments, a slightly different and/or larger design may be used to accommodate a front delivery system with an entire tray to be enclosed in the containment area.

In accordance with an exemplary embodiment of the present invention, the containment chamber may be configured as a compact device that is light weight and may be kept in small spaces, for example, small work place stage areas for easy access.

In some embodiments, the support component may include one or more wheels, for example, caster wheels, configured to enable the portability of the containment chamber. In an exemplary embodiment, a bottom side of the support component may include one or more wheels configured to permit the rolling movement of the containment chamber.

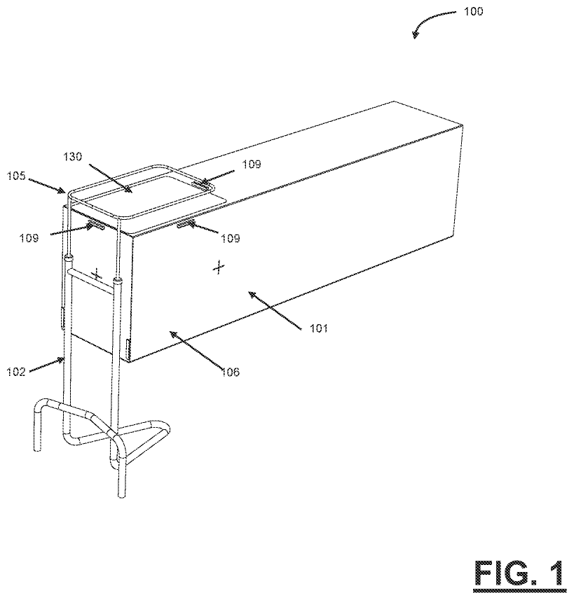

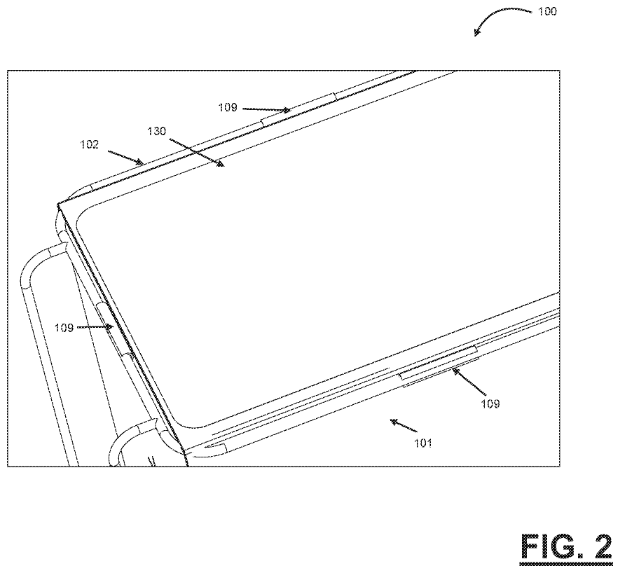

FIG. 1 shows a perspective view of an exemplary containment chamber with a chamber component disconnected from a support component in accordance with an embodiment of the present invention. FIG. 2 shows an expanded perspective view of an exemplary containment chamber with a chamber component connected to a support component in accordance with an embodiment of the present invention. As shown in FIGS. 1 and 2, a containment chamber 100 may generally comprise a chamber component 101. In some embodiments, a support component 102 may be configured to operably connect and provide structure to the chamber component 101. In any embodiment, the support component 102 and the chamber component 101 may each be comprised of one to a plurality of sub-components. In some embodiments, the support component 102 may be configured as a frame configured to connect to and support the chamber component 101. For example, at least a portion of the chamber component 101 may be configured to secure to the support component 102 such that the support component 102 may define the structure (i.e. the general shape) of the portion of the chamber component 101 and may be adapted to support the viewing window 130 of the chamber component 101. As shown in the depicted examples, in some embodiments, clips 109 may be utilized to selectively fasten the chamber component 101 to a support component 102. In some examples, the clips 109 may be c-shaped cylinders formed with or otherwise connected to an edge portion of the barrier 106 and may be adapted to connect to the frame 105 of the support component 102. In some embodiments, the clips 109 may be any other similarly suitable releasable fastener such as hook and loop fasteners, magnets, snap buttons, zippers, and other similar releasable fasteners.

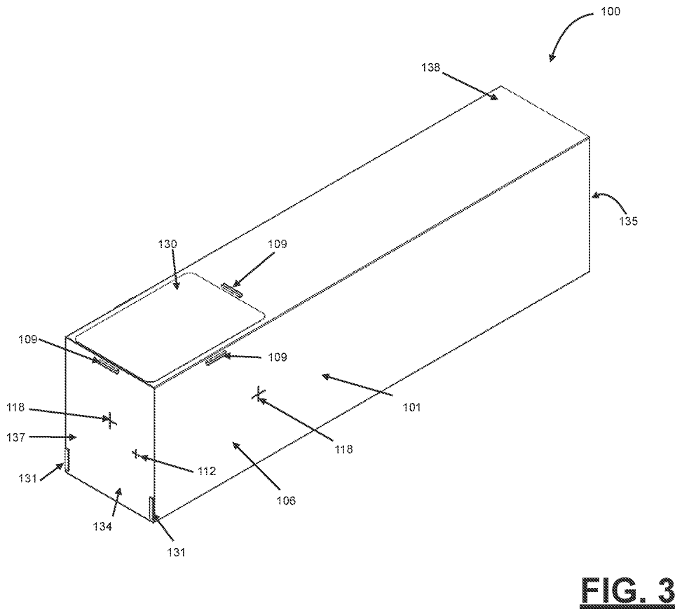

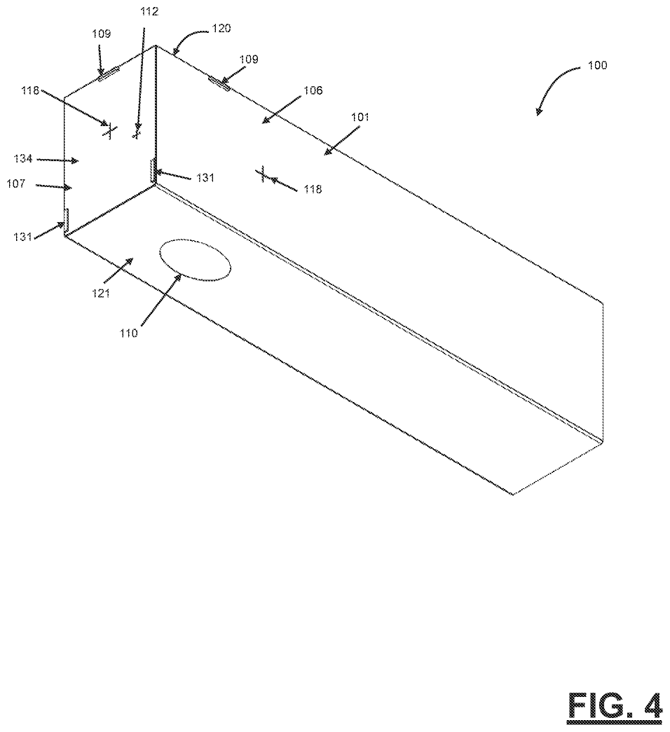

FIG. 3 shows a top perspective view of an exemplary chamber component of a containment chamber in accordance with an embodiment of the present invention. FIG. 4 shows a bottom perspective view of an exemplary chamber component of a containment chamber in accordance with an embodiment of the present invention. As shown in FIGS. 3 and 4, the chamber component 101 may comprise a barrier 106 having one or more sidewalls 107. As demonstrated in FIGS. 2 and 3, the barrier 106 may comprise five or more sidewalls 107. In the depicted example, a top side wall 120 of the barrier 106 opposes a bottom side wall 121 of the barrier 106. As shown in the depicted embodiment, the top side wall 120 may comprise a viewing window 130 and the bottom side wall 121 may comprise an examination aperture 110. In some examples, one or more sidewalls 107 of the barrier 106 may include one or more hand-openings 118. In the depicted example, the hand-openings are slits, specifically, “+” shaped slits, configured to permit the insertion of a user's hands and/or arms into the containment chamber. In the depicted example, the barrier 106 is configured with a front portion 137 extending towards a rear portion 138 having a sealed end 135.

As further shown in FIGS. 3 and 4, the barrier 106 may include one to several hand-openings 118. In some embodiments, the hand-openings 118 may be provided in pairs. The hand-openings 118 may be formed in any shape suitable to permit a user's hand to be inserted into the chamber component 101, for example, circle, square or oval shaped openings. In the depicted example, the hand-openings 118 are configured as “+” shaped slits configured to allow a user to pass their hand through the barrier 106 of the chamber component 101, for example, through the thin, flexible material of the barrier 106 and into the chamber component 101. As further shown in the depicted example, the barrier 106 may include an examination aperture 110 configured to receive one or more patient body parts for examination, inspection or operation. In some embodiments, the hand-openings 118 may extend toward sleeves and/or gloves. In some embodiments, the hand-openings 118 may include a membrane, for example, a rubber membrane configured to prevent matter external to the containment chamber (apart from an operator's hands and/or arms) from entering the containment chamber environment, as well as assist in preventing particles within the containment chamber from escaping. In some embodiment, the membrane may be configured to permit the insertion of hands of an operator who is geared, for example, an operator wearing personal protective equipment (PPE) and gloves.

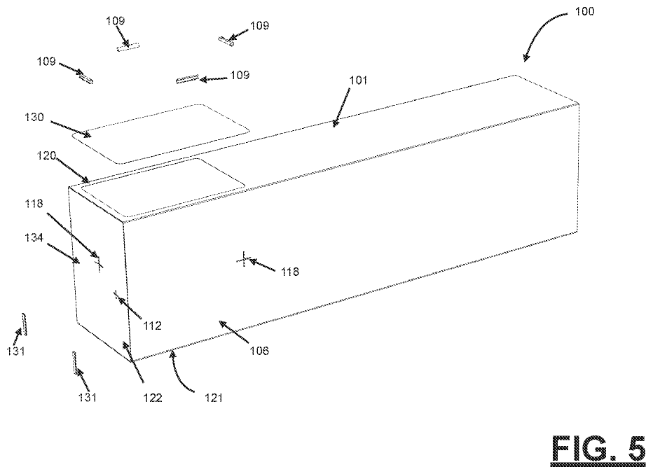

FIG. 5 shows an exploded view of an exemplary chamber component of a containment chamber in accordance with an embodiment of the present invention. As shown in FIG. 5, the chamber component 101 may comprise one or more side walls 107 having one or more examination apertures 110, one or more hand-openings 118, one or more ports 112 for power instruments and/or evacuation lines, and one or more viewing windows 130. As shown in the depicted example, in some embodiments, the chamber component 101 may include clips 109 adapted to permanently or releasably connect to the frame 105 of the support component 102. As further shown in the illustrated embodiment, the rear side wall 122 of the barrier 106 may include a safety flap 134 configured to enable the removal of instruments or tools from within the chamber component 101. In some embodiments, the flap 134 may be selectively opened and closed. In some embodiments, the safety flap 134 may be selectively closed by fastening one or more releasable fastener 131 such as hook and loop, button, clip or other similarly suitable fasteners.

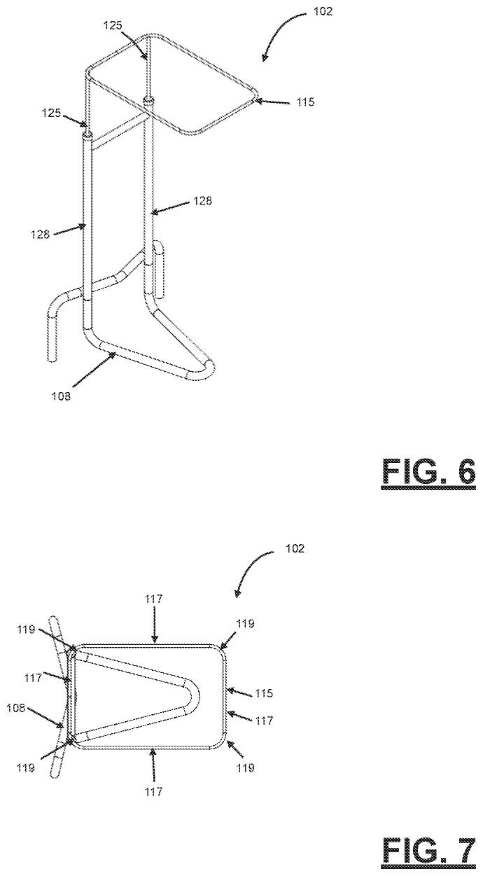

FIG. 6 shows a perspective view of an exemplary support component of a containment chamber in accordance with an embodiment of the present invention. As shown in the depicted example, the support component 102 may include a frame 105 having one or more supporting posts 128 configured to support and provide structure to the barrier 106 of the chamber component 101. In some examples, the frame 105 may comprise a top frame section having a support mount 115 and a bottom frame section having a base 108. In some embodiments, the base 108 may comprise one or more wheels, for example, castor wheels. As shown in the illustrated example, in some embodiments, the top frame section may be configured to receive and support at least a portion of the chamber component 101. In the depicted example, the top section of the frame 105 comprises a support mount 115 having one or more support rods 117 adapted to support at least a portion of the chamber component 101, for example, the viewing window 130 of the chamber component 101. In any embodiment, the support mount 115 may be configured to provide structural support to the chamber component 101.

FIG. 7 shows a top view of an exemplary support component of a containment chamber in accordance with an embodiment of the present invention. As shown in FIG. 7, the support mount 115 may comprise one or more support rods 117 adapted connected by one or more elbow shaped connector members 119 configured to support at least a portion of the chamber component 101, for example, the viewing window 130 of the chamber component 101.

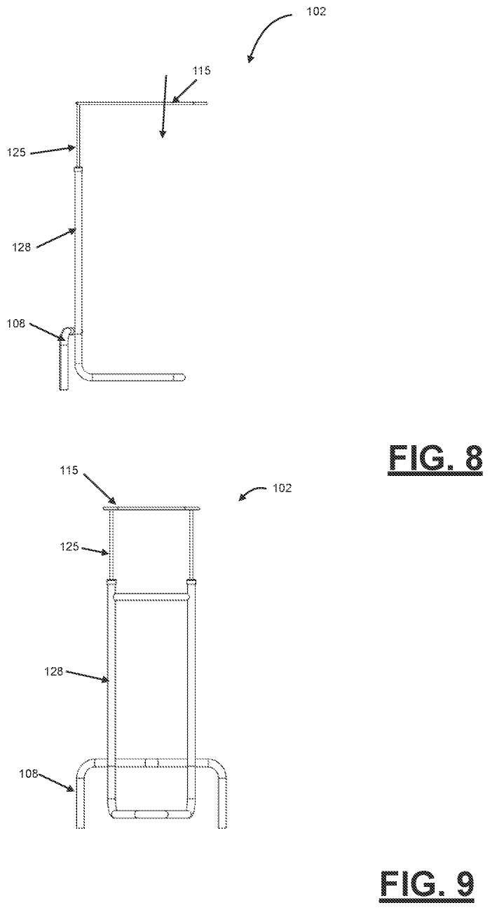

EEGs. 8 and 9 respectively show first and second side views of an exemplary support component of a containment chamber in accordance with an embodiment of the present invention. As shown in FIGS. 8 and 9, the support posts 128 supporting the support mount 115 may comprise telescoping components 125 configured to permit height adjustment, for example, to increase the distance between the support mount 115 and the base 108. For example, in some embodiments, the telescoping components 125 may be configured to enable adjustment of the height of the support component 102, for example, between a height of 34 to 55 inches.

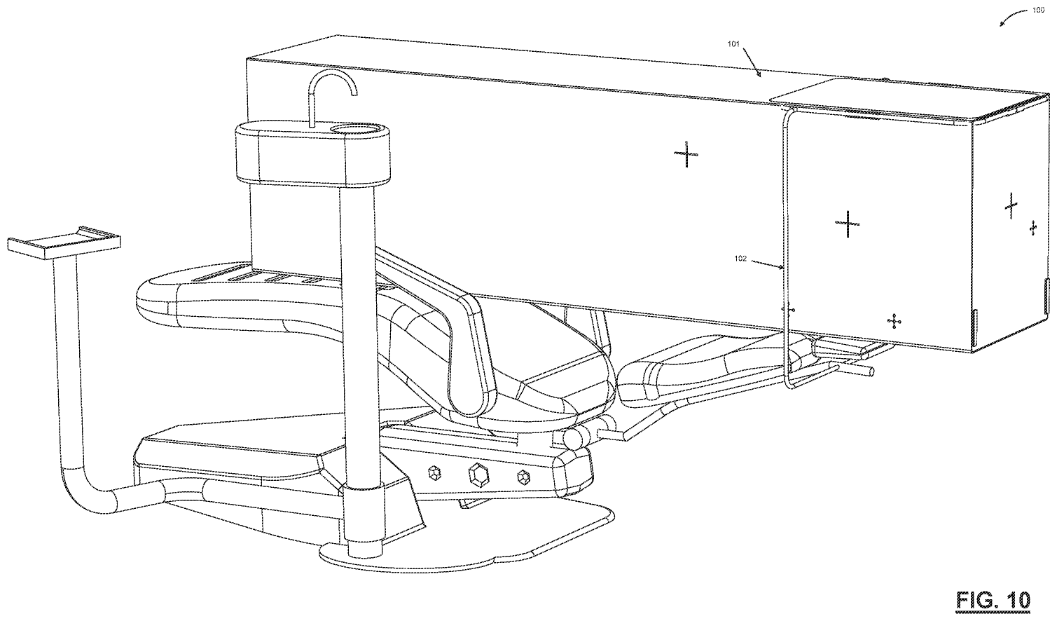

FIG. 10 shows a perspective view of an exemplary containment chamber connected to a medical chair in accordance with an embodiment of the present invention. As shown in the exemplary scenario, the support component 102 may be operably connected to a medical chair, for example, attached to or installed under a medical chair such that a patient may be seated on the medical chair and the chamber component 101 may be placed on top of the seated patient. The support component may connect to the medical chair in any suitable way for the purpose of having the chamber component 101 placed on top of a seated patient.

In any embodiment, the support component 102 may be formed in any suitable shape including, for example, circular, diamond, square, rectangular, rhomboid, hexagonal, or any other shape. In some embodiments, the dimensions of the support component 102 may vary depending on the size of an intended user (e.g. patient). In some embodiments, the support component 102 may be adjustable or fixed. In some embodiments, the support component may be secured to a surface (i.e. fixed or immobile), for example, a chair, table, or may be mobile.

Although the depicted example demonstrates a substantially rectangular prism shaped chamber component 101, the chamber component 101 may be configured in a plurality of shapes, for example, substantially square, hexagonal, triangular, circular, and oval based shapes or prisms.

In any example, the chamber component 101 may be reusable or disposable. For example, the support component 102 may be comprised of a material washable and/or disinfectable material that may be washed or disinfected after use, such that a clean chamber component 101 may be utilized for subsequent uses. Moreover, the chamber component 101 may be disposable, such that a new chamber component 101 may be installed upon the support component 102 prior to each use, such that a sterile environment may be achieved at the outset of any given operation or procedure.

In an exemplary usage scenario, the containment chamber of the present disclosure may be designed for protection against the spread of microorganisms, for example, bacteria or viruses which are able to be carried by aerosolized droplets. The chamber may be configured to assist in reducing the risk of cross-contamination in a given location, for example, a dental operatory field wherein dentists, dental assistants or technicians are required to perform dental procedures. The chamber may also protect a person (e.g. a patient) from being exposed to contaminants in the air during a procedure. In some scenarios, a person (e.g. a patient) may rest or sit in a chair, and the containment chamber may be placed on top and/or around the person. The containment chamber of the present disclosure may similarly be used in additional scenarios, including in medical, aesthetic, and other settings, by the appropriate professionals in those fields, for example, medical doctors, technicians, hygienists, and aestheticians.

In another exemplary usage scenario, the containment chamber may be assembled to allow for a special design containment bag which custom fits inside the containment chamber (whether incorporating a fixed or mobile frame work) which comfortably allows a user, for example, a dentist and/or an assistant and all instruments including handpieces and vacuum lines to enter inside one or more one-way holes or ports. The containment chamber may be cleaned or evacuated by inverting and collapsing the barrier of the chamber component. Upon the completion of a procedure, the containment chamber assembly may allow for easy and effective collapse, disposal or sterilization of all the parts. The containment chamber may increase the safety for users, for example, dental working staff, to acceptable limits. In some scenarios, any staff inside the operatory field may still wear the proper PPE gear and may use a rubber dam to further isolate the working field.

In an exemplary usage scenario, when a given procedure or examination is completed, the containment chamber, including any potentially infected areas or surfaces, may be disposed safely into a proper waste disposal unit.

While the invention has been described as being used for or on a “patient” the application of the device is not limited for use for or on a patient, and may be used for or on any given person.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of embodiments of the invention, even those disclosed solely in combination with other features of embodiments of the invention, may be combined in any configuration excepting those readily apparent to the person skilled in the art as nonsensical. Likewise, use of the singular and plural is solely for the sake of illustration and is not to be interpreted as limiting.

In the present disclosure, all embodiments where “comprising” is used may have as alternatives “consisting essentially of,” or “consisting of” In the present disclosure, any method or apparatus embodiment may be devoid of one or more process steps or components. In the present disclosure, embodiments employing negative limitations are expressly disclosed and considered a part of this disclosure.

Certain terminology and derivations thereof may be used in the present disclosure for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Many suitable methods and corresponding materials to make each of the individual parts of embodiment apparatus are known in the art. According to an embodiment of the present invention, one or more of the parts may be formed by machining, 3D printing (also known as “additive” manufacturing), CNC machined parts (also known as “subtractive” manufacturing), and injection molding, as will be apparent to a person of ordinary skill in the art. Metals, wood, thermoplastic and thermosetting polymers, resins and elastomers as described herein-above may be used. Many suitable materials are known and available and can be selected and mixed depending on desired strength and flexibility, preferred manufacturing method and particular use, as will be apparent to a person of ordinary skill in the art.

Any element in a claim herein that does not explicitly state “means for” performing a specified function, or “step for” performing a specific function, is not to be interpreted as a “means” or “step” clause as specified in 35 U.S.C. § 112 (f). Specifically, any use of “step of” in the claims herein is not intended to invoke the provisions of 35 U.S.C. § 112 (f).

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A containment chamber comprising:
a substantially hollow chamber component formed of at least one sheet of flexible material configured as a barrier having a first end portion with at least one opening substantially opposing a second end portion with at least one window, the barrier configured to substantially enclose a predetermined area around at least a portion of a patient body.

2. The containment chamber of claim 1, wherein the at least one sheet of flexible material is substantially formed of polyethylene.

3. The containment chamber of claim 2, wherein the at least one sheet of flexible material is disposable.

4. The containment chamber of claim 1, wherein at least one opening is configured to receive at least a portion of a patient body.

5. The containment chamber of claim 1, wherein at least one opening is configured to receive at least a portion of an operator hand.

6. The containment chamber of claim 1, wherein at least one opening is configured to receive at least a portion of a tool.

7. The containment chamber of claim 1, wherein the window is releasably fastened to the second end portion.

8. The containment chamber of claim 1, wherein a support mount provides structure to the chamber component.

9. The containment chamber of claim 1, wherein a sidewall disposed between the first and second end portions of the barrier includes a safety flap for selective opening to provide access to the interior of the chamber component.

10. A containment chamber comprising:
a substantially hollow chamber component formed of at least one sheet of flexible material configured as a barrier for substantially enclosing a predetermined area around at least a portion of a patient body and having an operatory field portion with a first sidewall comprising at least one aperture and substantially opposing a second sidewall comprising at least one window, and a disposal portion opposing the operatory field portion and having a sealed end; and
a support mount defining a frame adapted to operably connect to and support at least a portion of the chamber component.

11. The containment chamber of claim 10, wherein the flexible material of the chamber component is transparent and configured to substantially drape from the support mount.

12. The containment chamber of claim 11, wherein the chamber component further comprises one or more openings.

13. The containment chamber of claim 12, wherein the aperture is adapted to receive at least a portion of a patient body and at least one opening is adapted to receive at least a portion of an operator hand.

14. The containment chamber of claim 13, wherein the chamber component prevents microbial particles from escaping the containment chamber.

15. A containment chamber comprising:
a substantially hollow and structure-free chamber component formed of at least one sheet of non-rigid material configured as a barrier having an operatory field portion with a first sidewall comprising at least one opening and substantially opposing a second sidewall comprising at least one window, and a disposal portion opposing the operatory field portion and having a sealed end; and
a rigid support mount comprising one or more support rods defining a frame adapted to operably connect to and provide structure to least a portion of the chamber component.

16. The containment chamber of claim 15, wherein a portion of the chamber component is configured to drape from the support mount.

17. The containment chamber of claim 16, wherein the three-dimensional shape of the chamber component is substantially defined by the shape of the support mount.

18. The containment chamber of claim 17, wherein the chamber component prevents microbial particles from escaping the containment chamber.

19. The containment chamber of claim 15, wherein the support mount includes a base that is substantially affixed to a medical chair.

20. The containment chamber of claim 15, wherein the dimensions of the support mount are adjustable.
